(19) United States
(12) Patent Application Publication
(10) Pub. No.: US 2014/0164270 A1
(43) Pub. Date: Jun. 12, 2014

(54) Method, system and computer readable medium for recommending medium users

(71) Applicant: TENCENT TECHNOLOGY (SHENZHEN) COMPANY LIMITED, Shenzhen (CN)

(72) Inventors: Yu Fan, Shenzhen (CN); Junjun Yao, Shenzhen (CN); Yingjie Wo, Shenzhen (CN); Qingling Yan, Shenzhen (CN); Cong Wang, Shenzhen (CN)

(21) Appl. No.: 14/182,955

(22) Filed: Feb. 18, 2014

Related U.S. Application Data
(63) Continuation of application No. PCT/CN2013/070073, filed on Jan. 5, 2013.

(30) Foreign Application Priority Data
Feb. 24, 2012 (CN) 2012100466638

(51) Int. Cl. G06Q 50/00; G06Q 10/00

(52) U.S. Cl. CPC G06Q 50/01; G06Q 10/00
USPC 705/319

(57) ABSTRACT

The present disclosure provides a method for recommending medium users, which may include: determining a group of first users required to be recommended according to ranking information of respective first users and a behaviour model of a second user; filtering the group of first users required to be recommended according to a user relationship chain of the second user or saturation information of the group of first users; recommending a first user of the filtered group of first users to the second user. The present disclosure also provides a system for recommending medium users. Through the method and system according to the present disclosure, medium users may be recommended in a fair and reasonable manner

### CROSS REFERENCE TO RELATED APPLICATIONS

This is a continuation application of International Patent Application No.: PCT/CN2013/070073, filed on Jan. 05, 2013, which claims priority to Chinese Patent Application No.: 201210046663.8 filed on Feb. 24, 2012, the disclosure of which is incorporated by reference herein in its entirety.

### TECHNICAL FIELD

The present disclosure relates to the field of Internet technology, in particular to a method, a system and a computer readable medium for recommending medium users.

### BACKGROUND

Recently, with the popularization of Internet, microblog quickly becomes a popular internet product.

A significant feature of microblog is that there are a number of famous users from various fields, so that it may be easy for a normal user to interact with those famous users. Generally, to attract the enthusiasm of a user for participating in microblog, a microblog system generally recommends famous users to a new user or regularly recommends famous users to certain users. However, the method for recommending famous users may yield the following problems:

1. The more famous a user is, the more times he/she will be recommended to other users;

2. A user may tune in to many undesired famous users, so that the efficiency for a successful recommendation is reduced.

According to the method for recommending famous users adopted in the prior art, the possibility for successfully recommending a medium user is relatively low. Therefore, with the expansion of the number of medium users, a more efficient and fare method for recommending medium users is essentially required.

### SUMMARY

Therefore, the present disclosure provides a method, a system and a computer readable medium for recommending medium users, so as to recommend medium users fairly and effectively.

The present disclosure provides a method for recommending medium users, which may include: a group of first users required to be recommended is determined according to ranking information of respective first users and a behaviour model of a second user; the group of first users required to be recommended is filtered according to a user relationship chain of the second user or saturation information of the group of first users; a first user of the filtered group of first users is recommended to the second user.

The present disclosure also provides a system for recommending medium users, which may include: an analysis module configured to determine a group of first users required to be recommended according to ranking information of receptive first users and a behaviour model of a second user; a filtering module configured to filter the group of first users according to a user relationship chain of the second user or saturation information of the group of first users; a recommending module configured to recommend a first user in the filtered group of first users to the second user.

The present disclosure further provides a computer readable medium storing computer executable commands, wherein the computer executable commands are configured to perform the following operations: determining a group of first users required to be recommended according to ranking information of respective first users and a behaviour model of a second user; filtering the group of first users required to be recommended according to a user relationship chain of the second user or saturation information of the group of first users; recommending a first user of the filtered group of first users to the second user.

According to the method and the system for recommending medium users, a group of first users required to be recommended is determined according to ranking information of respective first users and a behaviour model of a second user. In this way, the first users desired by the second user will be recommended so as to improve the possibility of a successful recommendation. The group of first users is filtered through the user relationship chain, so as to prevent a first user that has been tuned in by a second user from being recommended repeatedly.medium user.

### BRIEF DESCRIPTION OF THE DRAWINGS

FIG. 1 shows a flowchart of a method for recommending medium users according to the present disclosure.

FIG. 2 shows a structure diagram of a system for recommending medium users according to the present disclosure.

### DETAILED DESCRIPTION

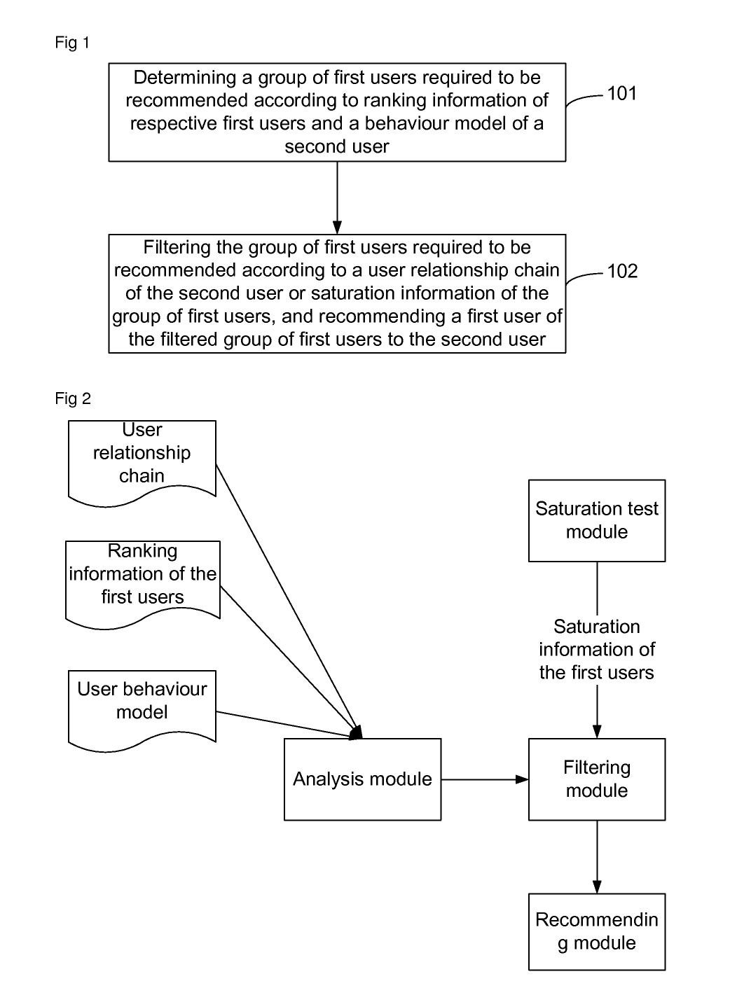

In recommendation of medium users, medium users whom have been recommended a certain times and medium users whom are undesired for a listener should be recommended fewer times or not be recommended. Therefore, the present disclosure provides a method for recommending medium users. As shown in FIG. 1, the method includes the following steps:

Step 101: a group of first users required to be recommended is determined according to ranking information of respective first users and a behaviour model of a second user.

Step 102: the group of first users required to be recommended is filtered according to a user relationship chain of the second user or saturation information of the group of first users.

For purpose of explanation, a medium user to be recommended is referred to as a first user; and a medium user to tune in the first user is referred to as a second user hereinafter.

The ranking information of the first users is provided by a microblog system and shows ranking of all medium users, i.e., each medium user may be the first user and the second user simultaneously. In one embodiment, a medium user may be ranked according to the number of times that he/she is tuned in, the more times that a medium user is tuned in, the higher the medium user is ranked. Additionally, ranking information of a first user includes at least a user ID (preferably, the user ID is a user name, or number assigned to the user by the system) and a place of the first user.

The behaviour model of a medium user is provided by the microblog system. The system may simulate the behaviour model of a medium user according to information such as personal information (profession, hobbies and interests filled in by the user) of the medium user and/or record of tuning in (e.g., the first user whom has been tuned in by the medium user). The behaviour model of a user includes one or more categories, to which the first users belong.

Based on the above two types of information, the step of determining a group of first users required to be recommended includes:

determining a category to which the group of first users belong according to the behaviour model of the second user; and

selecting a predetermined number of the first users that belong to the category in an order of rank from high to low according to the ranking information of the respective first users of the group of the first users, and generating the group of first users required to be recommended.

Additionally, the ranking information of the first users also includes the category to which the first users belong to. One micromblog user may belong to a plurality of categories simultaneously.

After the group of first users required to be recommended has been determined, a first user in the group of first users required to be recommended may be directly recommended to a second user. In this manner, the possibility of successfully recommending a first user to a second user will be higher. Additionally, for a more reasonable recommendation, the first users within the group of first users should be filtered. Specifically, the first users are filtered according to a user relationship chain of the second user or saturation information of respective first users.

In one embodiment, the user relationship chain is provided by the microblog system and shows all first users that have been tuned in by the second user, and then it is determined whether there is a first user in the group of first users to be recommended that has been tuned in by the second user according to the user relationship chain of the second user and the group of first users required to be recommended. Specifically, a matching is performed between first users included in the user relationship chain and first users included in the group of first users required to be recommended. If the matching is successful, it means that there is a first user in the group of first users that has already been tuned in by the second user, and then the first user that has been tuned in by the second user is deleted from the group of first users required to be recommended. In this way, the first user that has been tuned in by the second user will not be recommended to the second user repeatedly, and thus such a way for recommendation will be more appreciated.

The saturation information of the first users is provided by the microblog system. The saturation information of the first users is obtained through a saturation test for the first users in the group of first users, and includes a result of the saturation test, which indicates saturation or unsaturation.

Specifically, the saturation test may be performed in the following way.

(1). It is tested whether a total number of times that a first user in the group of first users required to be recommended has been tuned in achieves a predetermined maximum times, if yes, a test result indicates saturation, otherwise the test result indicates unsaturation.

(2). It is tested whether a number of times that a first user in the group of first users is recommended to the second user achieves a predetermined maximum times, if yes and the second user has not tuned in the first user, then the test result indicates saturation, if no and the second user has not tuned in the first user, then the test result indicates unsaturation.

The first users whose test results are saturation will be deleted from the group of first users required to be recommended.

According to the saturation test (1), the first user that has been tuned in more times will be prevented from being recommended more times. According to the saturation test (2), the problem of recommending a first user, which is not desired by the second user, to the second user repeatedly may be solved.

Additionally, the first users may be recommended to the second user regularly or when the second user is newly registered.

The present disclosure also provides a system for recommending medium users. As shown in FIG. 2, the system includes an analysis module, a filtering module and a recommending module.

The analysis module is configured to determine a group of first users required to be recommended according to ranking information of receptive first users and a behaviour model of a second user.

The filtering module is configured to filter the group of first users according to a user relationship chain of the second user or saturation information of the group of first users.

The recommending module is configured to recommend a first user in the filtered group of first users to the second user.

The analysis module is further configured to determine a category to which the group of first users belong according to the behaviour model of the second user, select a predetermined number of the first users that belong to the category in an order of rank from high to low according to the ranking information of the respective first users of the group of the first users, and generate the group of first users required to be recommended.

The filtering module is further configured to determining whether there is a first user in the group of first users to be recommended that has been tuned in by the second user according to the user relationship chain of the second user and the group of first users required to be recommended. If yes, then the first user that has been tuned in by the second user from the group of the first users required to be recommended is deleted.

Or, the filtering module may be configured to delete the first users whose test results are saturation from the group of first users required to be recommended.

The system also includes the following modules.

A saturation test module configured to perform a saturation test on respective first users of the group of first users required to be recommended. The saturation test comprises: test whether a total number of times that a first user in the group of first users required to be recommended has been tuned in achieves a predetermined maximum times, if yes, a test result indicates saturation, otherwise the test result indicates unsaturation; or, test whether a number of times that a first user in the group of first users is recommended to the second user achieves a predetermined maximum times, if yes and the second user has not tuned in the first user, then the test result indicates saturation, if no and the second user has not tuned in the first user, then the test result indicates unsaturation.

The saturation test module is further configured to provide the obtained saturation information of the first users to the filtering module. The saturation information for a first user includes the result of the saturation test on the first user, which is saturation or unsaturation.

If integrated modules described in the present disclosure are implementing by software function modules and are used or sold as a standalone product, they may be stored in a computer readable medium. Accordingly, the technical solutions or the parts that contribute to the prior art may be embodied as software products. The software product may be stored in a memory and include commands causing a computer device (such as a personal computer, a server or a network device) to perform a part or all of steps of the methods described above. The memory mentioned above includes any medium which can store program codes, such as a USB flash disk, a mobile hard disk drive, a Read-Only Memory (ROM), a Random Access Memory (RAM), a diskette or a CD. Therefore, the solutions of the present disclosure are not limited to combinations of any particular hardware and software.

Correspondingly, the present disclosure further provides a computer readable medium which stores computer program for implementing the method for recommending medium users as shown in FIG. 1.

It should be appreciated that the term “medium” according to the present disclosure may include but not limited to microblog, blog, news or instant communication.

Based on the saturation test, a first users that has been recommended too many times will be recommended fewer times in the future, and thus a scenario that a first user that has been tuned in more times will be prevented from being recommended more times. Meanwhile, the problem of recommending a first user, which is not desired by the second user, to the second user repeatedly may be solved. Therefore, the solutions for recommending medium users according to the present disclosure are more reasonable.

Those ordinarily skilled in the art would appreciate that the above steps or modules may be implemented by one or more processors with computer program running thereon. The computer program can be stored in a non-transitory computer-readable storage medium. When the computer program is executed, the above steps or modules can be included.

The above embodiments are described for purpose of explanation, and are not intended to limit the scope of the present disclosure.

1. A method for recommending medium users, comprising:
determining a group of first users required to be recommended according to ranking information of respective first users and a behaviour model of a second user;
filtering the group of first users required to be recommended according to a user relationship chain of the second user or saturation information of the group of first users;
recommending a first user of the filtered group of first users to the second user.

2. The method according to claim 1, wherein the step of determining a group of first users required to be recommended according to ranking information of respective first users of the group of the first users and a behaviour model of a second user comprises:
determining a category to which the group of first users belong according to the behaviour model of the second user;
selecting a predetermined number of the first users that belong to the category in an order of rank from high to low according to the ranking information of the respective first users of the group of the first users; and
generating the group of first users required to be recommended.

3. The method according to claim 1, wherein the step of filtering the group of the first users required to be recommended according to a user relationship chain of the second user comprises:
determining whether there is a first user in the group of first users to be recommended that has been tuned in by the second user according to the user relationship chain of the second user and the group of first users required to be recommended;
if yes, then deleting the first user that has been tuned in by the second user from the group of the first users required to be recommended, so as to obtain the filtered group of first users.

4. The method according to claim 2, further comprising:
performing a saturation test on respective first users of the group of first users required to be recommended, to obtain saturation information of the respective first users.

5. The method according to claim 4, wherein the step of performing a saturation test comprises:
testing whether a total number of times that a first user in the group of first users required to be recommended has been tuned in achieves a predetermined maximum times, if yes, a test result indicates saturation, otherwise the test result indicates unsaturation; or
testing whether a number of times that a first user in the group of first users is recommended to the second user achieves a predetermined maximum times, if yes and the second user has not tuned in the first user, then the test result indicates saturation, if no and the second user has not tuned in the first user, then the test result indicates unsaturation;
wherein the saturation information of the respective first users comprises the test result of the saturation test for the first users, and the test result indicates saturation or unsaturation.

6. The method according to claim 5, wherein the step of filtering the group of first users required to be recommended according to the saturation information of the respective first users comprises:
deleting the first users whose test result is saturation from the group of first users required to be recommended, to obtain the filtered group of first users.

7. A system for recommending medium users, comprising:
an analysis module configured to determine a group of first users required to be recommended according to ranking information of receptive first users and a behaviour model of a second user;
a filtering module configured to filter the group of first users according to a user relationship chain of the second user or saturation information of the group of first users;
a recommending module configured to recommend a first user in the filtered group of first users to the second user.

8. The system according to claim 7, wherein the analysis module is further configured to determine a category to which the group of first users belong according to the behaviour model of the second user, select a predetermined number of the first users that belong to the category in an order of rank from high to low according to the ranking information of the respective first users of the group of the first users, and generate the group of first users required to be recommended.

9. The system according to claim 7, wherein the filtering module is further configured to determining whether there is a first user in the group of first users to be recommended that has been tuned in by the second user according to the user relationship chain of the second user and the group of first users required to be recommended;
if yes, then deleting the first user that has been tuned in by the second user from the group of the first users required to be recommended, so as to obtain the filtered group of first users.

10. The system according to claim 9, the system further comprising:
a saturation test module configured to perform a saturation test on respective first users of the group of first users required to be recommended, wherein the saturation test comprises: test whether a total number of times that a first user in the group of first users required to be recommended has been tuned in achieves a predetermined maximum times, if yes, a test result indicates saturation, otherwise the test result indicates unsaturation; or test whether a number of times that a first user in the group of first users is recommended to the second user achieves a predetermined maximum times, if yes and the second user has not tuned in the first user, then the test result indicates saturation, if no and the second user has not tuned in the first user, then the test result indicates unsaturation;
wherein the saturation information of the respective first users comprises the test result of the saturation test for the first users, and the test result indicates saturation or unsaturation.

11. A computer readable medium storing computer executable commands, wherein the computer executable commands are executable for causing a computer to:
determine a group of first users required to be recommended according to ranking information of respective first users and a behaviour model of a second user;
filter the group of first users required to be recommended according to a user relationship chain of the second user or saturation information of the group of first users;
recommend a first user of the filtered of first users to the second user.

12. The computer readable medium according to claim 11, wherein the computer executable commands are further executable for causing the computer to:
determine a category to which the group of first users belong according to the behaviour model of the second user;
select a predetermined number of the first users that belong to the category in an order of rank from high to low according to the ranking information of the respective first users of the group of the first users; and
generate the group of first users required to be recommended.

13. The computer readable medium according to claim 12, wherein the computer executable commands are further executable for causing the computer to:
determine whether there is a first user in the group of first users to be recommended that has been tuned in by the second user according to the user relationship chain of the second user and the group of first users required to be recommended;
if yes, then delete the first user that has been tuned in by the second user from the group of the first users required to be recommended, so as to obtain the filtered group of first users.

14. The computer readable medium according to claim 12, wherein the computer executable commands are further executable for causing the computer to:
perform a saturation test on respective first users of the group of first users required to be recommended, to obtain saturation information of the respective first users.

15. The computer readable medium according to claim 14, wherein the computer executable commands are further executable for causing the computer to:
test whether a total number of times that a first user in the group of first users required to be recommended has been tuned in achieves a predetermined maximum times, if yes, a test result indicates saturation, otherwise the test result indicates unsaturation; or
test whether a number of times that a first user in the group of first users is recommended to the second user achieves a predetermined maximum times, if yes and the second user has not tuned in the first user, then the test result indicates saturation, if no and the second user has not tuned in the first user, then the test result indicates unsaturation;
wherein the saturation information of the respective first users comprises the test result of the saturation test for the first users, and the test result indicates saturation or unsaturation.

16. The computer readable medium according to claim 15, wherein the computer executable commands are further executable for causing the computer to:
delete the first users whose test result is saturation from the group of first users required to be recommended, to obtain the filtered group of first users.
